(19) United States
(12) Patent Application Publication
(10) Pub. No.: US 2022/0371340 A1
(43) Pub. Date: Nov. 24, 2022

(54) IMAGE FORMING APPARATUS AND IMAGE FORMING METHOD

(71) Applicant: Konica Minolta, Inc., Tokyo (JP)

(72) Inventor: Mitsuo KABURAGI, Tokyo (JP)

(21) Appl. No.: 17/743,855

(22) Filed: May 13, 2022

(30) Foreign Application Priority Data
May 19, 2021 (JP) 2021-084427

(51) Int. Cl. B41J 11/00

(52) U.S. Cl. CPC B41J 11/00242

(57) ABSTRACT

An image forming apparatus conveys a recording medium along a predetermined conveyance path and ejects ink onto a front surface of the recording medium to form an image when the recording medium passes through a predetermined drawing position, and includes: a first heater that is provided in the conveyance path on an upstream side of the drawing position and that heats the recording medium; and a control part that controls the first heater, wherein the first heater includes a front surface heater that heats a front surface side of the recording medium and a back surface heater that heats a back surface side of the recording medium, and the control part individually controls a temperature of the front surface heater and a temperature of the back surface heater when the recording medium has a multilayer structure.

### CROSS REFERENCE TO RELATED APPLICATIONS

The present invention claims priority under 35 U.S.C. § 119 to Japanese Application No. 2021-084427, filed on May 19, 2021, the entire contents of which being incorporated herein by reference.

### BACKGROUND

### Technological Field

The present invention relates to an image forming apparatus and an image forming method for forming an image on a recording medium by an inkjet method.

### Description of the Related art

An inkjet type image forming apparatus that ejects solvent-based ink to form an image on a recording medium conveys the recording medium such as a printing sheet along a predetermined conveyance path, and ejects ink melted at a high temperature when the recording medium passes through a predetermined drawing position, thereby forming an image on a surface of the recording medium. The ink placed on the surface of the recording medium spreads in a certain area on the surface of the recording medium to have a predetermined ink diameter and forms an image with predetermined resolution.

The manner of spread of the ink placed on the surface of the recording medium varies depending on temperatures. For example, in a case where the temperature of the recording medium is low, the ink placed onto the surface of the recording medium is immediately solidified, and thus, the ink does not have an ink diameter enough to fill a certain area, which leads to deterioration in image quality. When the temperature of the recording medium is too high, the ink placed onto the surface of the recording medium spreads beyond a certain area, and thus the ink diameter increases, causing an image blur. This also leads to deterioration in image quality.

On the other hand, techniques of heating a recording medium conveyed along a conveyance path before the recording medium reaches a drawing position have been conventionally known (for example, JP 2015-54437 A and JP 2014-139011 A). In these conventional techniques, the front surface temperature of the recording medium is controlled to be a predetermined temperature by heating the recording medium before the recording medium reaches the drawing position. As a result, an excessive decrease or excessive increase in the ink diameter of the ink placed on the surface of the recording medium at the drawing position can be suppressed to some extent.

However, when an image is formed on a recording medium having a multilayer structure such as a label sheet used for label printing, the above-mentioned conventional temperature control is difficult to control the front surface temperature of the recording medium during passage through the drawing position to a predetermined temperature. In general, a label sheet has a three-layer structure. Specifically, high-quality paper, a film, or the like is provided on the front surface side to which ink adheres, an adhesive layer is provided as an intermediate layer, and release paper or the like is provided on the back surface side. The thickness of each layer varies depending on the type of the recording medium, but in general, the high-quality paper, film, or the like on the front surface side is the thickest, and the adhesive layer, the release paper, or the like is thinner than that. In the recording medium having such a multilayer structure, the layers differ in material and thickness, and thus the layers have different heat transfer coefficients. In particular, the adhesive layer includes impurities and minute cavities, which causes unevenness in the heat transfer coefficient of the recording medium. Therefore, it is difficult to raise the temperature of the front surface of the recording medium to a predetermined temperature only by uniformly heating both the front surface and the back surface of the recording medium. Therefore, the conventional technique has a problem of having a difficulty in achieving an appropriate ink diameter and causing deterioration in image quality when a recording medium having a multilayer structure such as a label sheet is used.

### SUMMARY

In view of this, the present invention has been accomplished to solve the above problem, and an object thereof is to provide an image forming apparatus and an image forming method with which it is possible to achieve an appropriate ink diameter by raising the front surface temperature of a recording medium to an appropriate temperature, when a recording medium having a multilayer structure such as a label sheet is used.

To achieve the abovementioned object, according to an aspect of the present invention, there is provided an image forming apparatus that conveys a recording medium along a predetermined conveyance path and ejects ink onto a front surface of the recording medium to form an image when the recording medium passes through a predetermined drawing position, and the image forming apparatus reflecting one aspect of the present invention comprises: a first heater that is provided in the conveyance path on an upstream side of the drawing position and that heats the recording medium; and a control part that controls the first heater, wherein the first heater includes a front surface heater that heats a front surface side of the recording medium and a back surface heater that heats a back surface side of the recording medium, and the control part individually controls a temperature of the front surface heater and a temperature of the back surface heater when the recording medium has a multilayer structure.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a configuration example of an image forming apparatus.

FIG. 2A and FIG. 2B are diagrams illustrating an example of a cross-sectional structure of a recording medium having a single-layer structure and an ideal temperature profile thereof.

FIG. 3A and FIG. 3B are diagrams illustrating an example of a cross-sectional structure of a recording medium having a multilayer structure and an ideal temperature profile thereof.

FIG. 4 is a block diagram illustrating a configuration example of a controller.

FIG. 5 is a flowchart illustrating an example of a procedure of processing performed by the controller.

FIG. 6 is a diagram illustrating screen transition when a user designates a recording medium; and

FIG. 7 is a flowchart illustrating a procedure of processing performed by the controller in a case where a new recording medium is designated by the user.

### DETAILED DESCRIPTION OF EMBODIMENTS

Hereinafter, one or more embodiments of the present invention will be described with reference to the drawings. However, the scope of the invention is not limited to the disclosed embodiments. Note that, in the embodiment described below, elements common to each other are denoted by the same reference numerals, and redundant description thereof will be omitted.

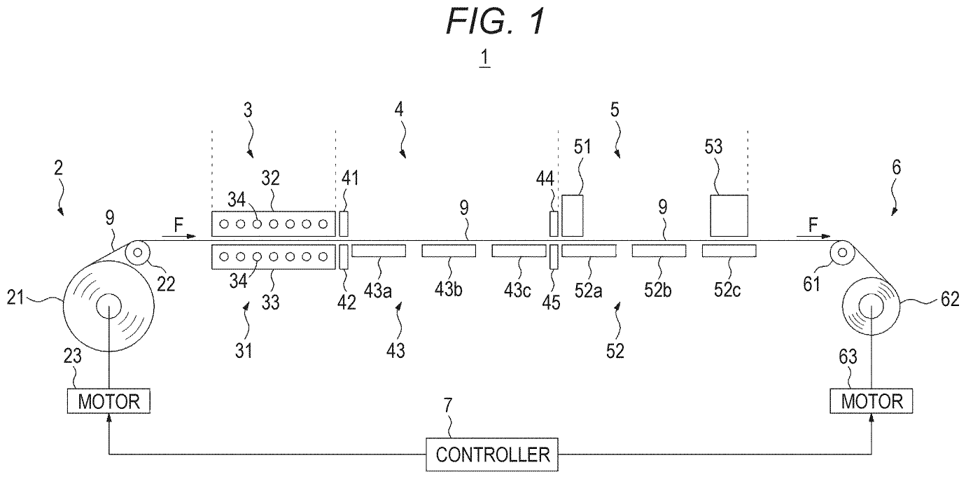

FIG. 1 is a diagram illustrating a configuration example of an image forming apparatus 1 according to one embodiment of the present invention. The image forming apparatus 1 conveys a recording medium 9 along a predetermined conveyance path and discharges a solvent-based ink onto the surface of the recording medium 9 at a predetermined drawing position in the conveyance path, thereby forming an image on the recording medium 9. The present embodiment will describe an example in which the image forming apparatus 1 conveys a long web-shaped recording medium 9 by a roll-to-roll process and ejects ink onto the surface of the long web-shaped recording medium 9 to form an image thereon.

The image forming apparatus 1 includes a sheet feeder 2, a preheater 3, an equalizing unit 4, an image former 5, a collector 6, and a controller 7. The image forming apparatus 1 conveys the recording medium 9 in a direction indicated by an arrow F from the sheet feeder 2 toward the collector 6. The preheater 3, the equalizing unit 4, and the image former 5 are arranged on a conveyance path formed between the sheet feeder 2 and the collector 6 in this order from the upstream side in the conveyance direction of the recording medium 9.

The sheet feeder 2 supplies the recording medium 9 toward the conveyance path. The sheet feeder 2 includes a sheet feed roller 21 around which the web-shaped recording medium 9 is wound, a roller 22, and a motor 23 that drives the sheet feed roller 21. For example, the motor 23 rotationally drives the shaft core of the sheet feed roller 21 to feed the web-shaped recording medium 9 toward the conveyance path via the roller 22. Note that the sheet feeder 2 feeds the recording medium 9 with the front surface (surface on which an image is formed by ink) facing upward.

The preheater 3 heats the recording medium 9 supplied from the sheet feeder 2. The preheater 3 includes a first heater 31. The first heater 31 can simultaneously heat both the front surface and the back surface of the recording medium 9. Specifically, the first heater 31 includes a front surface heater 32 and a back surface heater 33 that are disposed to face each other across the conveyance path of the recording medium 9. The front surface heater 32 heats the front surface side of the recording medium 9. The back surface heater 33 heats the back surface side of the recording medium 9. For example, each of the front surface heater 32 and the back surface heater 33 is a planar heater having a plurality of rod-shaped heaters 34 incorporated inside a metal plate member having high thermal conductivity. When the plurality of rod-shaped heaters 34 are driven, the temperature of the surface of the metal plate member facing the conveyance path is uniformly raised. A gap having a predetermined interval through which the recording medium 9 can pass is formed between the front surface heater 32 and the back surface heater 33, and the conveyance path is defined by the gap. The preheater 3 is provided in a section having a predetermined length along the conveyance direction of the recording medium 9. Therefore, the preheater 3 can continuously heat the front surface and the back surface of the recording medium 9 while the recording medium 9 is conveyed through the section of a predetermined length.

The equalizing unit 4 is for equalizing the temperature of the recording medium 9 heated by the preheater 3 and is provided on the downstream side of the preheater 3 in the conveyance direction of the recording medium 9. The equalizing unit 4 includes temperature sensors 41 and 42 that measure the temperature of the recording medium 9 fed from the preheater 3, a second heater 43 that heats the back surface side of the recording medium 9, and temperature sensors 44 and 45 that measure the temperature of the recording medium 9 at a timing immediately before the recording medium 9 enters the image former 5. The equalizing unit 4 is provided in a section having a predetermined length along the conveyance direction of the recording medium 9.

The temperature sensor 41 measures the front surface temperature of the recording medium 9 at a timing immediately after the recording medium 9 passes through the preheater 3. The temperature sensor 42 measures the back surface temperature of the recording medium 9 at a timing immediately after the recording medium 9 passes through the preheater 3. The temperature sensors 41 and 42 are installed at a plurality of locations in the width direction (direction orthogonal to the conveyance direction) of the recording medium 9, for example. Note that the temperature sensors 41 and 42 may be contact sensors that contact the front surface or the back surface of the recording medium 9 to measure the temperature or may be non-contact sensors such as infrared sensors.

The second heater 43 is disposed below the conveyance path of the recording medium 9 and heats the back surface side of the recording medium 9. The second heater 43 includes a plurality of heaters 43a, 43b, and 43c for heating the back surface side of the recording medium 9. Similarly, to, for example, the back surface heater 33 of the first heater 31, each of the heaters 43a, 43b, and 43c is a planar heater having a plurality of rod-shaped heaters incorporated inside a metal plate member having high thermal conductivity, by which the temperature of the upper surface of the metal plate member can be uniformly raised. When the recording medium 9 conveyed along the conveyance path is conveyed through the equalizing unit 4, the recording medium 9 is conveyed at a position close to the upper surface of the second heater 43 including the heaters 43a, 43b, and 43c. Although the present embodiment describes an example in which the second heater 43 is constituted by the plurality of heaters 43a, 43b, and 43c arranged along the conveyance path, the present invention is not limited thereto, and the second heater 43 may be constituted by a single heater. In that case, the single heater is disposed in an area where the single heater can cover from the start point to the end point of the equalizing unit 4 in the conveyance direction of the recording medium 9.

The temperature sensor 44 measures the front surface temperature of the recording medium 9 at a timing immediately before the recording medium 9 passing through the equalizing unit 4 enters the image former 5. The temperature sensor 45 measures the back surface temperature of the recording medium 9 at a timing immediately before the recording medium 9 passing through the equalizing unit 4 enters the image former 5. Similarly, to the temperature sensors 41 and 42 described above, the temperature sensors 44 and 45 are also installed at a plurality of locations in the width direction (direction orthogonal to the conveyance direction) of the recording medium 9, for example. In addition, the temperature sensors 44 and 45 may be contact sensors or non-contact sensors.

The image former 5 is a processor that forms an image with ink on the front surface of the recording medium 9 on the downstream side of the equalizing unit 4. The image former 5 includes an inkjet head 51 disposed on the upstream side in the conveyance direction of the recording medium 9, a third heater 52 that heats the back surface side of the recording medium 9, and a fixer 53 disposed on the downstream side in the conveyance direction of the recording medium 9. The image former 5 is provided in a section having a predetermined length along the conveyance direction of the recording medium 9.

The inkjet head 51 is provided at a position above a drawing position defined in the conveyance path of the recording medium 9. The inkjet head 51 ejects ink onto the front surface of the recording medium 9 passing through the drawing position to form an image corresponding to image data to be printed. For example, in the present embodiment, the drawing position is provided at a position immediately after an equalizing section by the equalizing unit 4 ends. In the present embodiment, since a solvent-based ink is used, the inkjet head 51 holds the ink in a molten state at a high temperature and discharges the molten ink droplet. The inkjet head 51 is filled with inks of four colors of yellow (Y), magenta (M), cyan (C), and black (K), and includes a large number of nozzles capable of individually ejecting the inks of the respective colors. The large number of nozzles are arranged at predetermined intervals along the width direction (main scanning direction) of the recording medium 9. Thus, the inkjet head 51 can form a color image on the recording medium 9.

The third heater 52 includes a plurality of heaters 52a, 52b, and 52c for heating the back surface side of the recording medium 9. Similarly, to, for example, the second heater 43, each of the heaters 52a, 52b, and 52c is a planar heater having a plurality of rod-shaped heaters incorporated inside a metal plate member having high thermal conductivity. When the recording medium 9 conveyed along the conveyance path is conveyed through the image former 5, the recording medium 9 is conveyed at a position close to the upper surface of the third heater 52 including the heaters 52a, 52b, and 52c. Although the present embodiment describes an example in which, similarly to the second heater 43, the third heater 52 is also constituted by the plurality of heaters 52a, 52b, and 52c, the present invention is not limited thereto, and the third heater 52 may be constituted by a single heater. In that case, the single heater is disposed in an area where the single heater can cover from the start point to the end point of the image former 5 in the conveyance direction of the recording medium 9.

The fixer 53 is disposed downstream of the inkjet head 51 and at a terminal position of the image former 5. The fixer 53 fixes the ink ejected onto the front surface of the recording medium 9 onto the front surface of the recording medium 9. For example, the ink used in the present embodiment is a UV ink having characteristics of being cured by irradiation with ultraviolet rays. Therefore, the fixer 53 is provided at a position above the conveyance path, irradiates the front surface of the recording medium 9 onto which the ink has been discharged with ultraviolet light to cure the ink, and fixes the ink on the front surface of the recording medium 9.

The collector 6 is for collecting the recording medium 9 having an image formed on a surface thereof by ink, and includes a roller 61, a winding roller 62, and a motor 63. The recording medium 9 fed from the image former 5 is conveyed toward the winding roller 62 via the roller 61 and is sequentially wound around the winding roller 62. For example, the motor 63 rotationally drives the shaft core of the winding roller 62 so that the recording medium 9 is wound around the winding roller 62.

The roller 22 of the sheet feeder 2 and the roller 61 of the collector 6 apply a constant tension to the recording medium 9 sequentially conveyed along the conveyance path through the preheater 3, the equalizing unit 4, and the image former 5. Therefore, when passing through each of the preheater 3, the equalizing unit 4, and the image former 5, the recording medium 9 maintains a certain positional relationship with each of the first heater 31, the second heater 43, and the third heater 52.

The controller 7 is a control part that controls the operation of each unit described above. For example, the controller 7 controls the motors 23 and 63 to control the conveyance speed of the recording medium 9. In addition, the controller 7 controls each of the first heater 31, the second heater 43, and the third heater 52 to control the temperature of the recording medium 9 conveyed along the conveyance path. Furthermore, the controller 7 determines whether or not the actual temperature profile of the recording medium 9 coincides with an ideal temperature profile on the basis of the temperature of the recording medium 9 measured by the temperature sensors 41, 42, 44, and 45. The controller 7 can control each of the first heater 31, the second heater 43, and the third heater 52 such that the actual temperature profile of the recording medium 9 coincides with an ideal temperature profile, and can also adjust the conveyance speed of the recording medium 9. When controlling the first heater 31, the controller 7 can apply the same temperature control to the front surface heater 32 and the back surface heater 33 and can also apply individual temperature control to the front surface heater 32 and the back surface heater 33.

Furthermore, the controller 7 controls the inkjet head 51 such that the ink with which the head is filled is maintained at a predetermined temperature and that the ink is ejected on the basis of the image data to be printed. Furthermore, the controller 7 irradiates the recording medium 9 with ultraviolet light and fixes the image formed by the ink on the recording medium 9 by controlling the fixer 53.

In the image forming apparatus 1 configured as described above, a medium having a single-layer structure such as plain paper can be used as the recording medium 9, and a medium having a multilayer structure such as a label sheet can also be used. The ink ejected from the inkjet head 51 has a high temperature of, for example, about 80° C. The fluidity of the molten ink increases with an increase in temperature and decreases with a decrease in temperature. In view of this, the controller 7 appropriately manages the front surface temperature of the recording medium 9 to control the ink diameter of the ink placed on the surface of the recording medium 9. For example, if it is necessary to maintain the front surface temperature of the recording medium 9 within a range of 40 to 45° C. in order to achieve an appropriate ink diameter, the target temperature of the recording medium 9 is 42 to 43° C. In this case, the controller 7 performs control so that the front surface temperature of the recording medium 9 reaches the target temperature until the recording medium 9 fed from the sheet feeder 2 reaches the drawing position where an image is formed by the inkjet head 51.

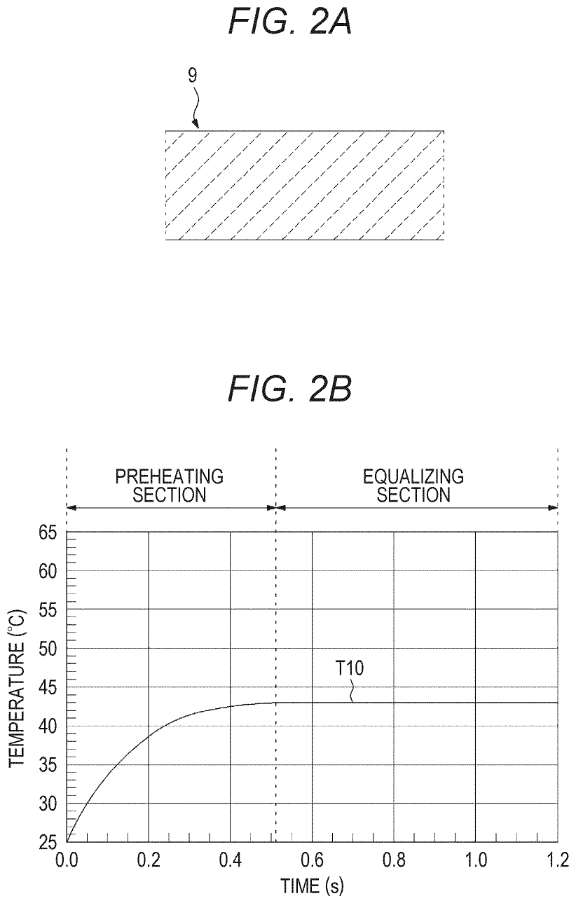

FIG. 2A illustrates a cross-sectional structure of the recording medium 9 having a single-layer structure. As illustrated in FIG. 2A, the inside of the recording medium 9 having a single-layer structure is constituted by a single material, and thus, the heat transfer coefficient of the recording medium 9 is uniform. Therefore, the controller 7 equally controls the front surface heater 32 and back surface heater 33 of the first heater 31. That is, the controller 7 performs control such that, when the recording medium 9 passes through the preheater 3, the temperature of the entire recording medium 9 including the front surface, the inside, and the back surface reaches a predetermined target temperature (for example, 43° C.) by uniformly heating the front surface and the back surface of the recording medium 9.

FIG. 2B illustrates an example of an ideal temperature profile of the recording medium 9 having a single-layer structure. The temperature profile illustrated in FIG. 2B indicates that a front surface temperature T10 of the recording medium 9 is raised to a predetermined target temperature by the preheater 3 and the raised front surface temperature is maintained in the equalizing unit 4. In order to achieve this temperature profile, the controller 7 performs heating control for heating the front surface heater 32 and the back surface heater 33 to equal temperatures when heating the recording medium 9 by the first heater 31 of the preheater 3. At this time, the controller 7 raises the temperature of both the front surface heater 32 and the back surface heater 33 to a temperature higher than the target temperature of the recording medium 9, thereby raising the front surface temperature of the recording medium 9 from the normal temperature (for example, 25° C.) to the predetermined target temperature (for example, 43° C.) while the recording medium 9 passes through the preheating section by the preheater 3. Then, the controller 7 sets the temperature of the second heater 43 provided in the equalizing unit 4 to the target temperature (for example, 43° C.) of the recording medium 9, and continues heating of the recording medium 9 also in the equalizing unit 4. As a result, in the equalizing unit 4, the front surface temperature T10 of the recording medium 9 is maintained at the target temperature. Therefore, when the recording medium 9 reaches the drawing position where an image is formed by the inkjet head 51, the front surface temperature of the recording medium 9 can be maintained at the predetermined target temperature, and thus, the ink placed on the front surface of the recording medium 9 can spread in a given area, whereby an appropriate ink diameter can be achieved.

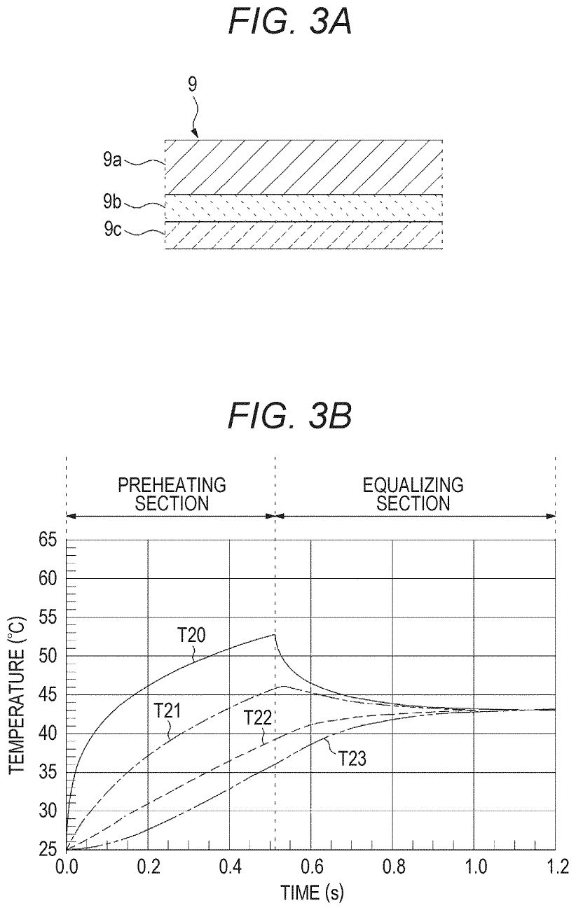

Next, FIG. 3A illustrates a cross-sectional structure of the recording medium 9 having a multilayer structure such as a label sheet. FIG. 3A illustrates a cross-sectional structure of the recording medium 9 having a three-layer structure. As illustrated in FIG. 3A, the recording medium 9 having a three-layer structure includes a first layer 9a including high-quality paper, a film, or the like disposed on the front surface side, a second layer 9b serving as an intermediate layer and including an adhesive or the like, and a third layer 9c including release paper or the like disposed on the back surface side. The layers of the recording medium 9 differ in material and thickness. Regarding particularly the thickness, the first layer 9a is the thickest, and the second layer 9b and the third layer 9c are thinner than the first layer 9a. In the recording medium 9 described above, the layers differ in heat transfer coefficient. Therefore, even if the front surface side and the back surface side of the recording medium 9 are equally heated, the front surface temperature and the back surface temperature of the recording medium 9 cannot be equally raised. In a case of discharging ink on the front surface of the recording medium 9 having a multilayer structure such as a label sheet, it is preferable that the back surface side and the inside of the recording medium as well as the front surface of the recording medium 9 are managed to have a predetermined target temperature. If the front surface side only has reached the target temperature and the back surface temperature and the internal temperature have not reached the target temperature, the front surface temperature immediately decreases, and thus, the ink cannot be spread to a certain area. In view of this, the controller 7 of the present embodiment is configured to individually control the front surface heater 32 and the back surface heater 33 of the first heater 31 when the recording medium 9 having a multilayer structure is used. Specifically, since the heat capacity of the first layer 9a is larger than those of the second layer 9b and the third layer 9c, the controller 7 performs control so that a large amount of heat is applied to the front surface side of the recording medium 9 and a smaller amount of heat than the amount of heat applied to the front surface side is applied to the back surface side, when the recording medium 9 passes through the preheater 3. Then, the controller 7 controls the equalizing unit 4 so that each of the front surface, the inside, and the back surface of the recording medium 9 has a predetermined target temperature.

FIG. 3B illustrates an example of an ideal temperature profile of the recording medium 9 having a multilayer structure. The temperature profile illustrated in FIG. 3B illustrates a front surface temperature T20 of the first layer 9a, a temperature T21 at a boundary between the first layer 9a and the second layer 9b, a temperature T22 at a boundary between the second layer 9b and the third layer 9c, and a back surface temperature T23 of the third layer 9c. This temperature profile indicates that the surface temperature T20 of the recording medium 9 is raised to a temperature higher than a predetermined target temperature (for example, 43° C.) in the preheating section by the preheater 3, and the back surface temperature T23 is raised to a temperature lower than the predetermined target temperature, and then, the front surface temperature T20 and the back surface temperature T23 of the recording medium 9 are controlled to coincide with the predetermined target temperature in the equalizing section by the equalizing unit 4.

In order to achieve this temperature profile, the controller 7 sets the set temperature of the front surface heater 32 and the set temperature of the back surface heater 33 to different temperatures, and individually controls the front surface heater 32 and the back surface heater 33, when heating the recording medium 9 by the first heater 31 of the preheater 3. Specifically, the controller 7 performs control to raise the temperature of the back surface heater 33 to a predetermined target temperature (for example, 43° C.) and raise the temperature of the front surface heater 32 to a temperature higher than the target temperature (for example, about 70° C.). That is, the controller 7 sets the temperature of the front surface heater 32 to a temperature higher than the predetermined target temperature, sets the temperature of the back surface heater 33 to the predetermined target temperature, and simultaneously heats both the front and back surfaces of the recording medium 9. As a result, in the preheating section, the front surface side of the recording medium 9 is heated by the front surface heater 32 to have the front surface temperature T20 higher than the predetermined target temperature. On the other hand, the back surface side of the recording medium 9 is heated by the back surface heater 33, and thus, a rate of temperature rise is lower than that on the front surface side. In addition, since the recording medium 9 passes through the preheating section in about 0.5 seconds, the back surface heater 33 cannot raise the back surface temperature T23 of the recording medium 9 to the predetermined target temperature and heats the recording medium 9 to a temperature lower than the predetermined target temperature. Therefore, as illustrated in FIG. 3B, the recording medium 9 immediately after passing through the preheating section is in a state where the front surface temperature T20 has risen to a temperature higher than the target temperature, and the back surface temperature T23 has risen to a temperature lower than the target temperature. At this time, the boundary temperatures T21 and T22 inside the recording medium 9 are between the front surface temperature T20 and the back surface temperature T23. Further, the boundary temperature T21 between the first layer 9a and the second layer 9b is higher than the boundary temperature T22 between the second layer 9b and the third layer 9c.

The controller 7 performs heating as described above in the preheating section, and then heats only the back surface side of the recording medium 9 so that the front surface temperature T20 and the back surface temperature T23 of the recording medium 9 coincide with each other at the target temperature (for example, 43° C.) by the equalizing unit. At this time, the controller 7 sets the temperatures of the plurality of heaters 43a, 43b, and 43c of the second heater 43 to the predetermined target temperature (for example, 43° C.), and heats only the back surface side of the recording medium 9.

In the equalizing section, the front surface side of the recording medium 9 is not heated, and thus, release of heat progresses. Therefore, the temperature of the front surface side heated to a temperature higher than the target temperature by the preheater 3 gradually decreases. Therefore, when the recording medium 9 enters the equalizing section, the front surface temperature T20 of the recording medium 9 gradually decreases as illustrated in FIG. 3B. Then, when the equalizing section ends, the front surface temperature T20 of the recording medium 9 coincides with the target temperature.

On the other hand, the back surface side of the recording medium 9 is continuously heated by the second heater 43. Therefore, even after the recording medium 9 enters the equalizing section, the back surface temperature T23 of the recording medium 9 continuously rises. Then, when the equalizing section ends, the back surface temperature T23 of the recording medium 9 reaches the target temperature.

Therefore, when the equalizing section ends, both the front surface temperature T20 and the back surface temperature T23 of the recording medium 9 coincide with the target temperature. At this time, the boundary temperatures T21 and T22 inside the recording medium 9 also coincide with the target temperature, and the temperature is equalized without having a temperature unevenness inside the recording medium 9. That is, when an image is formed using the recording medium 9 having a multilayer structure, the controller 7 controls each of the first heater 31 and the second heater 43 so that a temperature profile as illustrated in FIG. 3B is obtained, and performs control so that both the front surface temperature T20 and the back surface temperature T23 of the recording medium 9 coincide with the predetermined target temperature (for example, 43° C.) when the recording medium 9 reaches the drawing position. As a result, when the recording medium 9 having a multilayer structure reaches the drawing position, the front surface temperature T20 of the recording medium 9 can be raised to the predetermined target temperature, and thus, an appropriate ink diameter can be achieved.

During the conveyance of the recording medium 9 having a multilayer structure, the controller 7 acquires the front surface temperature T20 and the back surface temperature T23 of the recording medium 9 measured by the temperature sensors 41, 42, 44, and 45. Then, the controller 7 creates an actual temperature profile from when the recording medium 9 enters the preheating section until the recording medium 9 reaches the drawing position on the basis of the actually measured front surface temperature T20 and back surface temperature T23, and determines whether or not the actual temperature profile coincides with the ideal temperature profile. When the actual temperature profile does not coincide with the ideal temperature profile as a result of the determination, the controller 7 performs control so that the actual temperature profile reaches the ideal temperature profile by adjusting one or both set temperature of the front surface heater 32 and the conveyance speed of the recording medium 9.

Furthermore, the controller 7 controls the third heater 52 so that the front surface temperature T20 of the recording medium 9 does not suddenly change until the recording medium 9 passes through the fixer 53 after an image is formed with ink at the drawing position. For example, the controller 7 sets the temperatures of the plurality of heaters 52a, 52b, and 52c of the third heater 52 to a predetermined target temperature (for example, 43° C.), and heats only the back surface side of the recording medium 9. Due to this control, the heat-retaining state of the recording medium 9 is maintained, whereby it is possible to suppress a rapid decrease in the front surface temperature T20 of the recording medium 9 before the recording medium 9 reaches the fixer 53, and it is also possible to maintain the front surface temperature T20 of the recording medium 9 in a constant state until the recording medium 9 completely passes through the fixer 53.

Meanwhile, the ink ejected onto the front surface of the recording medium 9 at the drawing position has a high temperature of about 80° C. Therefore, when a large amount of ink is discharged onto the front surface of the recording medium 9, the front surface temperature T20 of the recording medium 9 temporarily rises, and the ink diameter may increase. In order to prevent this phenomenon, the controller 7 may calculate a drawing rate with respect to the recording medium 9 (the ratio of the drawing area to the entire paper surface) on the basis of the image data to be printed and adjust the set temperature of the third heater 52 on the basis of the drawing rate. For example, in a case where the drawing rate is larger than a predetermined value, the controller 7 sets the set temperature of each of the heaters 52a, 52b, and 52c in the third heater 52 to a temperature lower than the predetermined target temperature (for example, 43° C.), and promotes heat release from the front surface of the recording medium 9, thereby preventing the front surface temperature T20 from being temporarily higher than the target temperature. At this time, the controller 7 may uniformly lower the set temperatures of the plurality of heaters 52a, 52b, and 52c, or may set only the set temperature of the heater 52a located immediately below the inkjet head 51 to a lower temperature. In addition to lowering the set temperature of each of the heaters 52a, 52b, and 52c, the controller 7 may turn off the power of each of the heaters 52a, 52b, and 52c to stop the heating process.

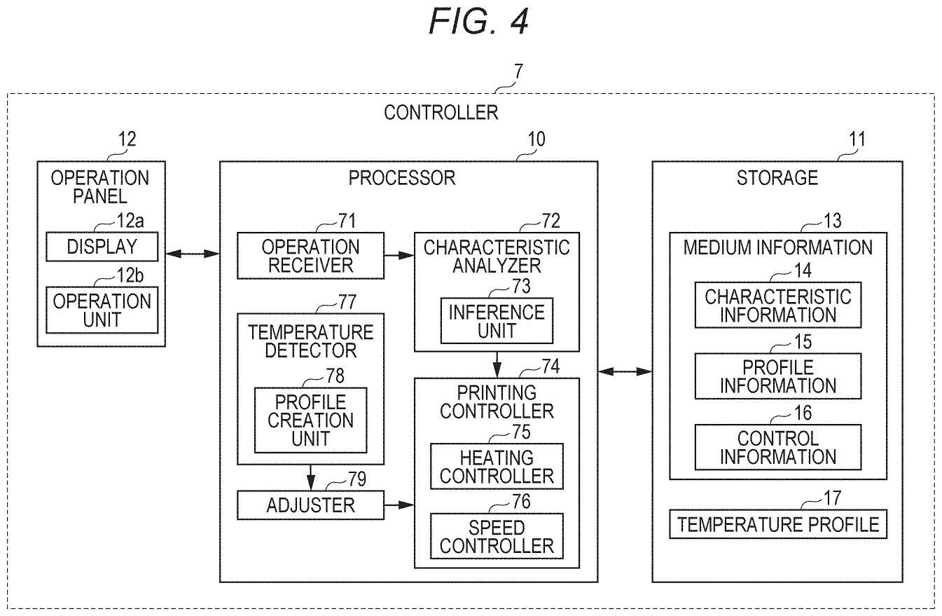

Next, details of the controller 7 that performs the above control will be described. FIG. 4 is a block diagram illustrating a configuration example of the controller 7. The controller 7 includes a processor 10, a storage 11, and an operation panel 12. The processor 10 is a hardware processor that performs various types of arithmetic processing for the above-described control by executing a predetermined computer-readable program. The storage 11 is a nonvolatile storage device including, for example, a hard disk drive (HDD), a solid-state drive (SSD), or the like. The operation panel 12 serves as a user interface when the user operates the image forming apparatus 1.

The storage 11 stores medium information 13 related to the recording medium 9 registered in advance in the image forming apparatus 1. The medium information 13 includes characteristic information 14 indicating characteristics of the recording medium 9, profile information 15 indicating an ideal temperature profile of the recording medium 9, and control information 16 for achieving the ideal temperature profile. In the characteristic information 14, for example, information such as the material and thickness of each layer forming the multilayer structure is recorded. In the profile information 15, for example, a temperature profile as illustrated in FIG. 3B is recorded. Information such as set temperatures of the front surface heater 32 and the back surface heater 33 of the first heater 31, a set temperature of the second heater 43, a set temperature of the third heater 52, and a conveyance speed of the recording medium 9 is recorded in the control information 16.

In addition, the storage 11 stores an actual temperature profile 17 created on the basis of temperatures measured by the temperature sensors 41, 42, 44, and 45 during conveyance of the recording medium 9.

The operation panel 12 includes a display 12a that displays a screen operable by the user, and an operation unit 12b that receives an operation performed by the user. The user can perform an operation of selecting or designating the recording medium 9 on the operation panel 12.

The processor 10 functions as an operation receiver 71, a characteristic analyzer 72, a printing controller 74, a temperature detector 77, and an adjuster 79 by executing a predetermined program.

The operation receiver 71 receives an operation of selecting or designating the recording medium 9 performed by the user. For example, the operation receiver 71 reads the medium information 13 from the storage 11 and displays a list screen of recording media 9 registered in advance in the image forming apparatus 1 on the display 12a of the operation panel 12. The user can select the recording medium 9 to be used for image formation from the list screen.

The characteristic analyzer 72 analyzes the characteristics of the recording medium 9 designated by the user, and on the basis of the characteristics, sets the conveyance speed and the target temperature of the recording medium 9 and determines an ideal temperature profile corresponding to the recording medium 9. The characteristic analyzer 72 then sets temperatures of the first heater 31, the second heater 43, and the third heater 52 to be raised. For example, when the user selects the recording medium 9 registered in advance in the image forming apparatus 1, the characteristic analyzer 72 reads the medium information 13 of the recording medium 9 selected by the user, and on the basis of the control information 16 included in the medium information 13, determines the conveyance speed and the target temperature of the recording medium 9 and determines the set temperature for each of the first heater 31, the second heater 43, and the third heater 52.

The characteristic analyzer 72 includes an inference unit 73. The inference unit 73 is a processing unit that, in a case where a new recording medium 9 is designated by the user, infers an ideal temperature profile corresponding to the new recording medium 9. Note that details of processing performed by the inference unit 73 will be described later.

The printing controller 74 performs printing control on the recording medium 9 on the basis of a job execution start instruction from the user. The printing controller 74 controls the operations of the sheet feeder 2, the preheater 3, the equalizing unit 4, the image former 5, and the collector 6 to form an image based on image data to be printed on the front surface of the recording medium 9. The printing controller 74 includes a heating controller 75 and a speed controller 76. The heating controller 75 drives each of the first heater 31, the second heater 43, and the third heater 52 and raises the temperatures of the respective heaters to the temperature determined by the characteristic analyzer 72, thereby controlling the heating process on the recording medium 9. The speed controller 76 controls the conveyance speed of the recording medium 9.

During the conveyance of the recording medium 9, the temperature detector 77 acquires the temperatures measured by the temperature sensors 41, 42, 44, and 45 and detects the front surface temperature and the back surface temperature of the recording medium 9. The temperature detector 77 includes a profile creation unit 78. The profile creation unit 78 creates an actual temperature profile on the basis of the front surface temperature and the back surface temperature of the recording medium 9 measured by the temperature sensors 41, 42, 44, and 45. After creating the actual temperature profile, the profile creation unit 78 stores the created temperature profile in the storage 11. In addition, after creating the actual temperature profile, the profile creation unit 78 compares the actual temperature profile with an ideal temperature profile. In a case where the actual temperature profile does not coincide with the ideal temperature profile as a result of comparison, the profile creation unit 78 activates the adjuster 79.

When the actual temperature profile does not coincide with the ideal temperature profile, the adjuster 79 adjusts the actual temperature profile to be the ideal temperature profile by rewriting the control information 16. For example, the adjuster 79 performs control so that the actual temperature profile coincides with the ideal temperature profile by adjusting one or both of the set temperature of the front surface heater 32 and the conveyance speed of the recording medium 9 included in the control information 16.

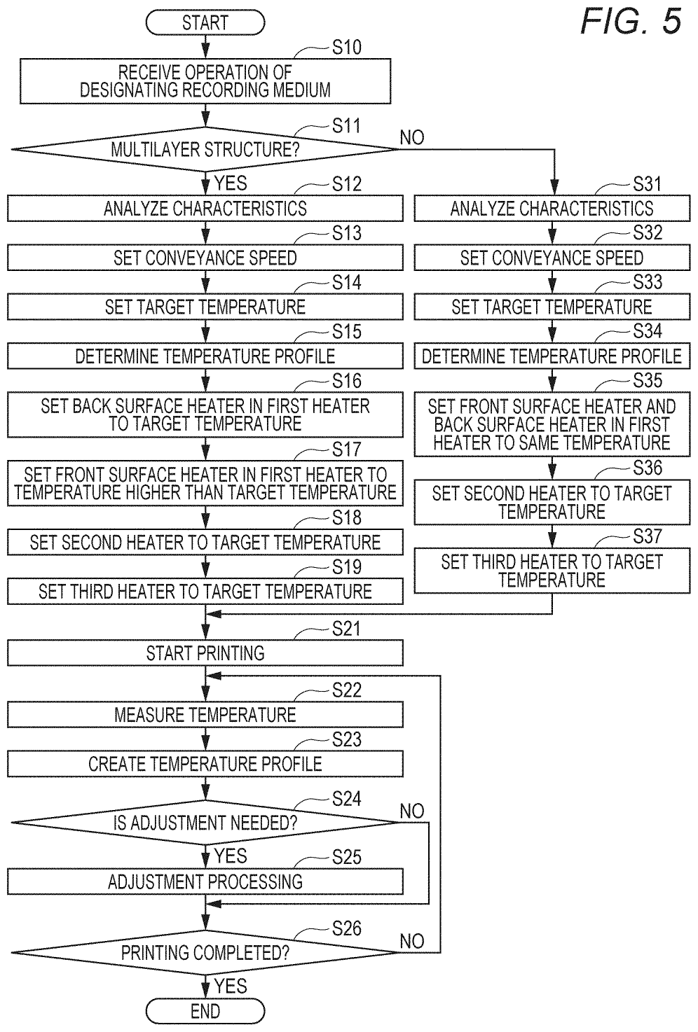

FIG. 5 is a flowchart illustrating an example of a procedure of processing performed by the controller 7. First, the controller 7 receives an operation of designating the recording medium 9 performed by the user (step S10). When the recording medium 9 is designated by the user, the controller 7 determines whether or not the recording medium 9 having a multilayer structure is designated (step S11). When the recording medium 9 having a multilayer structure is designated (YES in step S11), the controller 7 reads the medium information 13 from the storage 11 and analyzes the characteristics of the recording medium 9 on the basis of the characteristic information 14 included in the medium information 13 (step S12). Then, the controller 7 sets the conveyance speed of the recording medium 9 on the basis of the control information 16 included in the medium information 13 (step S13) and sets the target temperature of the recording medium 9 (step S14). Subsequently, the controller 7 determines an ideal temperature profile on the basis of the profile information 15 included in the medium information 13 (step S15). With this process, the temperature profile as illustrated in FIG. 3B is determined as the ideal temperature profile.

Subsequently, the controller 7 sets a temperature of the back surface heater 33 of the first heater 31 to be raised to the target temperature of the recording medium 9 on the basis of the control information 16 (step S16). That is, the controller 7 sets the target temperature of the recording medium 9 as the target temperature of the back surface heater 33. In addition, the controller 7 sets the temperature of the front surface heater 32 of the first heater 31 to be raised to a temperature higher than the target temperature of the recording medium 9 on the basis of the control information 16 (step S17). How much higher than the target temperature of the recording medium 9 the temperature of the front surface heater 32 is set depends on the characteristics of the recording medium 9. It is to be noted, however, that, since the temperature of the front surface heater 32 to be set to achieve the ideal temperature profile is recorded in advance in the control information 16, the controller 7 sets the temperature of the front surface heater to the temperature recorded in the control information 16.

Next, the controller 7 sets the temperatures of the plurality of heaters 43a, 43b, and 43c constituting the second heater 43 to be raised to the target temperature of the recording medium 9 (step S18). In addition, the controller 7 sets the temperatures of the plurality of heaters 52a, 52b, and 52c constituting the third heater 52 to be raised to the target temperature of the recording medium 9 (step S19). It is to be noted, however, that, as described above, the controller 7 may set the temperatures of the plurality of heaters 52a, 52b, and 52c to be raised to a temperature lower than the target temperature of the recording medium 9 on the basis of the drawing rate based on the image data.

When the temperature setting for the first heater 31, the second heater 43, and the third heater 52 is completed in the manner described above, the controller 7 drives each of the first heater 31, the second heater 43, and the third heater 52 for warming-up before starting the printing operation. When the warming-up is completed, the controller 7 conveys the recording medium 9 and starts printing on the recording medium 9.

When the printing operation is started, the controller 7 measures the front surface temperature and the back surface temperature of the recording medium 9 on the basis of the outputs from the temperature sensors 41, 42, 44, and 45 (step S22), and creates an actual temperature profile (step S23). Then, the controller 7 compares the actual temperature profile with the ideal temperature profile and determines whether or not adjustment is necessary (step S24). When the adjustment is necessary (YES in step S24), the controller 7 adjusts one or both of the set temperature of the front surface heater 32 and the conveyance speed of the recording medium 9 so that the actual temperature profile coincides with the ideal temperature profile (step S25). When the adjustment is not necessary (NO in step S24), step S25 is skipped.

Thereafter, the controller 7 determines whether or not printing has been completed (step S26). In a case where the printing has not been completed, the controller 7 repeats the processes of steps S22 to S25 described above. When the printing is completed, the processing performed by the controller 7 ends.

On the other hand, when the recording medium 9 designated by the user does not have a multilayer structure (NO in step S11), the controller 7 determines that the recording medium 9 has a single-layer structure. In this case, the controller 7 reads the medium information 13 from the storage 11 and analyzes the characteristic of recording medium 9 on the basis of the characteristic information 14 included in the medium information 13 (step S31). Then, the controller 7 sets the conveyance speed of the recording medium 9 on the basis of the control information 16 included in the medium information 13 (step S32) and sets the target temperature of the recording medium 9 (step S33). Subsequently, the controller 7 determines an ideal temperature profile on the basis of the profile information 15 included in the medium information 13 (step S34). As a result, the temperature profile as illustrated in FIG. 2B is determined as the ideal temperature profile.

Then, the controller 7 sets the temperature of the front surface heater 32 and the back surface heater 33 of the first heater 31 to the same temperature on the basis of the control information 16 (step S35). At this time, the temperature set for the front surface heater 32 and the back surface heater 33 is higher than the target temperature of the recording medium 9. How much higher than the target temperature of the recording medium 9 the temperature of the front surface heater 32 and the back surface heater 33 is set depends on the characteristics of the recording medium 9. It is to be noted, however, that, since the temperature of the front surface heater 32 and the back surface heater 33 to be set to achieve the ideal temperature profile is recorded in advance in the control information 16, the controller 7 sets the temperatures of the front surface heater 32 and the back surface heater 33 to the temperature recorded in the control information 16.

Next, the controller 7 sets the temperatures of the plurality of heaters 43a, 43b, and 43c constituting the second heater 43 to be raised to the target temperature of the recording medium 9 (step S18). In addition, the controller 7 sets the temperatures of the plurality of heaters 52a, 52b, and 52c constituting the third heater 52 to be raised to the target temperature of the recording medium 9 (step S19). It is to be noted, however, that, as described above, the controller 7 may set the temperatures of the plurality of heaters 52a, 52b, and 52c to be raised to a temperature lower than the target temperature of the recording medium 9 on the basis of the drawing rate based on the image data.

Thereafter, the controller 7 performs the processes of steps S21 to S26 in the same manner as described above to form an image on the recording medium 9 having a single-layer structure. However, in a case where it is determined in step S24 that adjustment is necessary when printing is performed on the recording medium 9 having a single-layer structure, the controller 7 adjusts the set temperatures of both the front surface heater 32 and the back surface heater 33 instead of adjusting only the temperature of the front surface heater 32.

Due to the controller 7 executing the processing described above, the ink diameter of the ink ejected onto the recording medium 9 can be controlled to be constant, and thus, degradation in image quality can be suppressed. In particular, even in a case where the recording medium 9 having a multilayer structure is designated as the recording medium 9, an ideal temperature profile according to the characteristics of the recording medium 9 having a multilayer structure is achieved, so that a high-quality image can be formed on the front surface of label sheet or the like.

In addition, in order that the recording medium 9 having a multilayer structure has an ideal temperature profile, the controller 7 employs a relatively simple control of individually controlling the front surface heater 32 and the back surface heater 33 of the first heater 31 to raise the temperature of the front surface heater 32 to be higher than the temperature of the back surface heater 33. Therefore, it is not necessary to perform complicated control, and thus, there is an advantage that the ink diameter can be managed in a constant state without increasing the load of the processor 10.

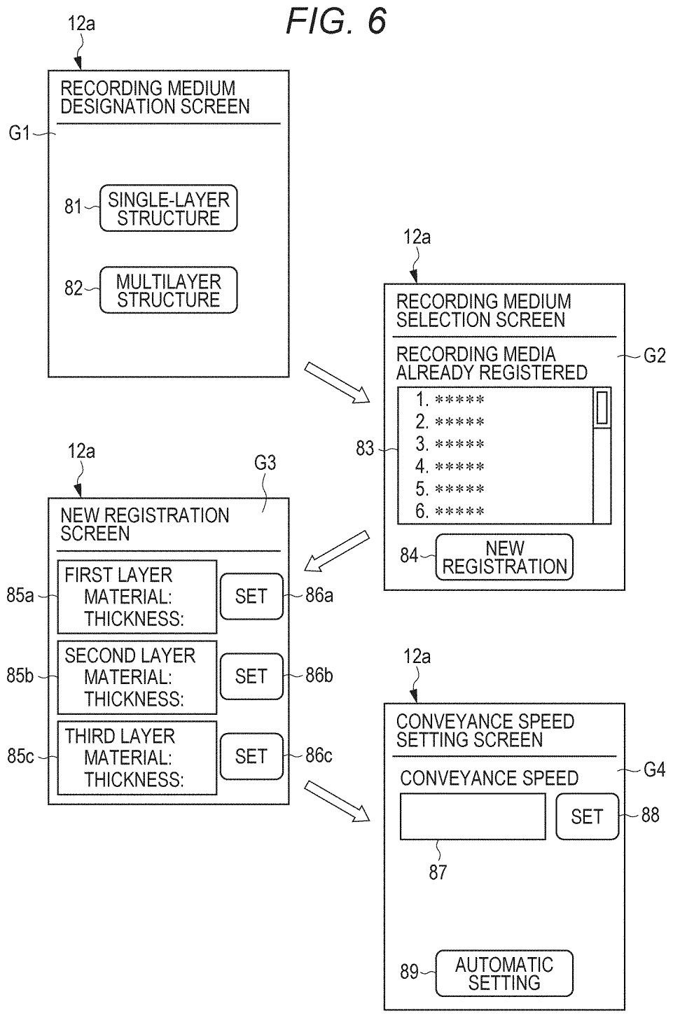

Next, processing in a case where a new recording medium 9 is designated by the user will be described. FIG. 6 is a diagram illustrating screen transition when the user designates the recording medium 9. When the user designates the recording medium 9, a recording medium designation screen G1 is first displayed on the display 12a of the operation panel 12. The recording medium designation screen G1 displays a button 81 for designating a single-layer structure and a button 82 for designating a multilayer structure as the structure of the recording medium 9. For example, when the user operates the button 82 for designating a multilayer structure, the screen displayed on the display 12a transitions to a recording medium selection screen G2. The recording medium selection screen G2 displays a list display 83 and a button 84 for performing new registration. The list display 83 displays a list of the recording media 9 having a multilayer structure already registered in the image forming apparatus 1. Therefore, the user can select the recording medium 9 to be used for image formation from among the plurality of recording media 9 displayed on the list display 83. On the other hand, when the recording medium 9 to be used for image formation is not included in the list display 83, the user operates the button 84 for new registration.

When the user operates the button 84 for new registration, the screen displayed on the display 12a transitions to a new registration screen G3. The new registration screen G3 displays a display field 85a for displaying the characteristics of the first layer, a display field 85b for displaying the characteristics of the second layer, and a display field 85c for displaying the characteristics of the third layer together with a plurality of setting buttons 86a, 86b, and 86c which are displayed at positions adjacent to the display fields 85a, 85b, and 85c. For example, the user can set the characteristic information 14 of the new recording medium 9 by inputting the material and thickness of each layer constituting the new recording medium 9 in each of the display fields 85a, 85b, and 85c and by operating the setting buttons 86a, 86b, and 86c. When the characteristic information 14 is input by the user, the controller 7 generates the medium information 13 corresponding to the new recording medium 9 and stores the generated medium information in the storage 11.

When the characteristic information is input by the user, the screen displayed on the display 12a transitions to a conveyance speed setting screen G4. The conveyance speed setting screen G4 displays a conveyance speed display field 87, a setting button 88, and an automatic setting button 89. When manually setting the conveyance speed of the recording medium 9, the user may input a desired speed in the display field 87 and operate the setting button 88. When performing automatic setting, the user may operate the automatic setting button 89. For example, when the user operates the automatic setting button 89, the controller 7 automatically sets the conveyance speed at which the maximum throughput can be achieved in the image forming apparatus 1.

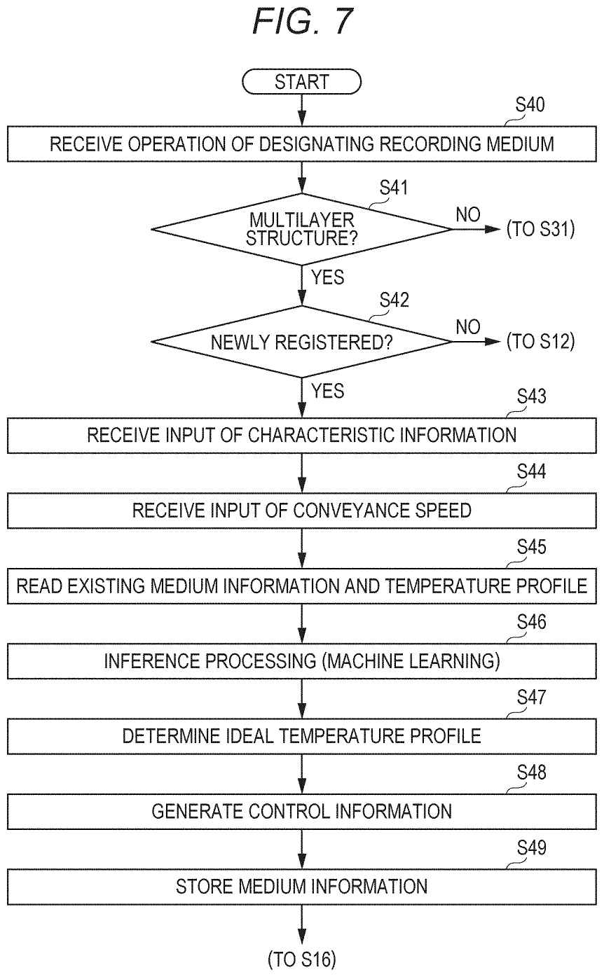

FIG. 7 is a flowchart illustrating a procedure of processing in a case where a new recording medium 9 is designated by the user. The processing procedure illustrated in FIG. 7 is performed in place of the processes of steps S10 to S15 illustrated in FIG. 5. First, the controller 7 receives an operation of designating the recording medium 9 performed by the user (step S40). When the recording medium 9 is designated by the user, the controller 7 determines whether or not the recording medium 9 having a multilayer structure is designated (step S41). When the user designates a single-layer structure instead of a multilayer structure (NO in step S41), the processing by the controller 7 proceeds to step S31 in FIG. 5. When the recording medium 9 having a multilayer structure is designated by the user (YES in step S41), the controller 7 determines whether or not the designated recording medium 9 is newly registered (step S42). When the designated recording medium 9 is not newly registered (NO in step S42), the processing by the controller 7 proceeds to step S12 in FIG. 5. On the other hand, when the designated recording medium 9 is newly registered (YES in step S42), the controller 7 displays the new registration screen G3 on the display 12a and receives the input of the characteristic information 14 by the user (step S43). Subsequently, the controller 7 displays the conveyance speed setting screen G4 on the display 12a and receives an input of the conveyance speed from the user (step S44).

Subsequently, the controller 7 starts processing for determining an ideal temperature profile corresponding to the new recording medium 9 designated by the user. First, the controller 7 reads the existing medium information 13 and the temperature profile 17 stored in the storage 11 (step S45). In a case where the medium information 13 and the temperature profiles 17 of a plurality of recording media 9 are stored, the controller 7 reads all the medium information 13 and the temperature profiles 17 respectively corresponding to the plurality of recording media 9. Then, the controller 7 executes inference processing of inferring a temperature profile to be applied to the new recording medium 9 on the basis of the medium information 13 and the temperature profiles 17 read from the storage 11 (step S46). At this time, the controller 7 performs machine learning using the medium information 13 and the temperature profiles 17 read from the storage 11 as training data to derive a temperature profile most suitable to be applied to the new recording medium 9. Then, the controller 7 determines the temperature profile derived by the inference processing as an ideal temperature profile corresponding to the new recording medium 9 (step S47). When the ideal temperature profile is determined, the controller 7 determines temperatures of the front surface heater 32 and the back surface heater 33 of the first heater 31, a temperature of the second heater 43, and a temperature of the third heater 52 by which the ideal temperature profile can be achieved while referring to the control information 16 included in the existing medium information 13, and generates the control information 16 corresponding to the new recording medium 9 (step S48). Then, the controller 7 creates the medium information 13 including the characteristic information 14, the profile information 15, and the control information 16, and stores the created medium information 13 in the storage 11 (step S49). Therefore, when the same recording medium 9 is used thereafter, the medium information 13 stored in the storage 11 can be used.

Thereafter, the processing by the controller 7 proceeds to step S16 in FIG. 5. That is, the controller 7 performs temperature setting based on the medium information 13 created in step S49, performs warming-up, and then starts printing. Then, in a case where the actual temperature profile created based on the front surface temperature and the back surface temperature of the recording medium 9 measured using the temperature sensors 41, 42, 44, and 45 does not coincide with the ideal temperature profile determined in step S47, the controller 7 preferably performs adjustment processing (step S25) and corrects the control information 16 included in the medium information 13 on the basis of the result of the adjustment processing.

Due to the execution of the processing as described above in the controller 7, even when the new recording medium 9 is used, it is possible to automatically create an ideal temperature profile corresponding to the new recording medium 9 by utilizing the medium information 13 and the temperature profile 17 based on actual measurement which are already registered in the image forming apparatus 1. Therefore, in the case of using a new recording medium 9, there is no need for the user to create an ideal temperature profile, which provides an advantage that printing can be efficiently started.

Furthermore, in a case of using a new recording medium 9, the user may perform test printing at the start of printing and verify whether or not the image quality reaches the desired image quality. When the image quality does not reach the desired image quality as a result of verifying the printed matter by the test printing, the user manually changes the setting of the temperature of the front surface heater 32 of the first heater 31 or changes the setting of the conveyance speed of the recording medium 9. In addition, the user may manually correct the ideal temperature profile. When the setting is changed or the ideal temperature profile is corrected by the user, the controller 7 changes the control information 16 and the profile information 15 of the medium information 13 to values specified by the user. As a result, the medium information 13 corresponding to the new recording medium 9 is updated to information reflecting the test printing result. Thus, when the actual printing is performed after the test printing, an image with high image quality desired by the user can be formed.

The preferred embodiment of the present invention has been described above. However, the present invention is not limited to the details described in the above embodiment, and various modifications can be applied.

For example, the above embodiment describes an example in which the image forming apparatus 1 conveys the web-shaped recording medium 9 by the roll-to-roll process. However, the image forming apparatus according to the present invention is not necessarily limited to an apparatus that conveys the recording medium 9 by the roll-to-roll process. That is, the heating control (temperature control) described in the above embodiment can also be applied to an image forming apparatus that feeds sheets stacked and placed on the sheet feeder 2 one by one and sequentially conveying the fed sheet to a conveyance path.

In addition, the above embodiment describes the case where each of the front surface heater 32 and the back surface heater 33 constituting the first heater 31 employs a planar heater. However, each of the front surface heater 32 and the back surface heater 33 is not necessarily limited to employing a planar heater. For example, the front surface heater 32 and the back surface heater 33 may employ roller-shaped heaters which are arranged to face each other across the conveyance path of the recording medium 9. In this case, the upper roller-shaped heater with respect to the conveyance path is provided as the front surface heater 32, and the lower roller-shaped heater is provided as the back surface heater 33. The roller-shaped heaters form a nip portion and rotate while holding the recording medium 9 in the nip portion, thereby conveying the recording medium 9 to the downstream side in the conveyance direction. The first heater 31 may be provided with a plurality of sets of such roller-shaped heaters along the conveyance direction of the recording medium 9. Note that the same configuration can also be applied to the second heater 43 or the third heater 52.

It is to be noted, however, that the roller-shaped heaters can heat the recording medium 9 only when the recording medium 9 is nipped at the nip portion. Even in a case where, for example, a plurality of sets of roller-shaped heaters are provided, the front surface temperature of the recording medium 9 can be raised only in a stepwise manner, and thus, the heating efficiency decreases. For this reason, when the above-described temperature control is applied, the preheating section increases in length, entailing a problem of an increase in size of the apparatus. Therefore, in order to prevent an increase in size of the apparatus, each of the front surface heater 32 and the back surface heater 33 constituting the first heater 31 preferably employs a planar heater as described in the above embodiment.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus that conveys a recording medium along a predetermined conveyance path and ejects ink onto a front surface of the recording medium to form an image when the recording medium passes through a predetermined drawing position, the image forming apparatus comprising:
a first heater that is provided in the conveyance path on an upstream side of the drawing position and that heats the recording medium; and
a control part that controls the first heater,
wherein the first heater includes a front surface heater that heats a front surface side of the recording medium and a back surface heater that heats a back surface side of the recording medium; and
the control part individually controls a temperature of the front surface heater and a temperature of the back surface heater when the recording medium has a multilayer structure.

2. The image forming apparatus according to claim 1, wherein the control part raises the temperature of the back surface heater to a predetermined target temperature and raises the temperature of the front surface heater to a temperature higher than the predetermined target temperature.

3. The image forming apparatus according to claim 1, wherein the control part performs control so that a front surface temperature of the recording medium and a back surface temperature of the recording medium coincide with a predetermined target temperature when the recording medium reaches the drawing position.

4. The image forming apparatus according to claim 1, further comprising
a second heater that is provided between the first heater and the drawing position and that heats a back surface side of the recording medium,
wherein the control part further controls the second heater.

5. The image forming apparatus according to claim 4, wherein the control part raises a temperature of the second heater to a predetermined target temperature.

6. The image forming apparatus according to claim 4, wherein the control part allows the recording medium to reach the drawing position with the front surface temperature of the recording medium being maintained at a predetermined target temperature by controlling the second heater.

7. The image forming apparatus according to claim 1, further comprising:
a fixer that is provided in the conveyance path on a downstream side of the drawing position and that fixes the ink ejected onto the front surface of the recording medium; and
a third heater that is provided between the drawing position and the fixer and that heats a back surface side of the recording medium,
wherein the control part further controls the third heater.

8. The image forming apparatus according to claim 7, wherein the control part raises a temperature of the third heater to a predetermined target temperature.

9. The image forming apparatus according to claim 7, wherein the control part calculates a drawing rate for the recording medium on the basis of image data to be printed and sets a temperature of the third heater on the basis of the drawing rate.

10. The image forming apparatus according to claim 7, wherein the control part allows the recording medium to reach the fixer with the front surface temperature of the recording medium being maintained at a predetermined target temperature by controlling the third heater.

11. The image forming apparatus according to claim 1, wherein the control part sets a temperature of the front surface heater to be raised according to characteristics of the recording medium.

12. The image forming apparatus according to claim 1, wherein the control part sets a conveyance speed of the recording medium according to characteristics of the recording medium.

13. The image forming apparatus according to claim 11, wherein the characteristics of the recording medium include a material and a thickness of each layer forming the multilayer structure.

14. The image forming apparatus according to claim 1, further comprising
a temperature measurer that measures a front surface temperature and a back surface temperature of the recording medium conveyed along the conveyance path,
wherein the control part adjusts the temperature of the front surface heater on the basis of the front surface temperature and the back surface temperature of the recording medium measured by the temperature measurer.

15. The image forming apparatus according to claim 1, further comprising
a temperature measurer that measures a front surface temperature and a back surface temperature of the recording medium conveyed along the conveyance path,
wherein the control part adjusts a conveyance speed of the recording medium on the basis of the front surface temperature and the back surface temperature of the recording medium measured by the temperature measurer.

16. The image forming apparatus according to claim 1, further comprising
a storage that stores medium information in which characteristic information of the recording medium and control information for achieving an ideal temperature profile for the recording medium are associated with each other for each type of the recording medium,
wherein, in a case where a medium having the medium information which is already stored in the storage is designated as the recording medium, the control part reads the medium information from the storage, and individually controls the temperature of each of the front surface heater and the back surface heater on the basis of the control information.

17. The image forming apparatus according to claim 16, further comprising
a temperature measurer that measures, at a plurality of locations, a front surface temperature and a back surface temperature of the recording medium conveyed along the conveyance path,
wherein the control part creates a temperature profile of the recording medium on the basis of the front surface temperature and the back surface temperature of the recording medium measured by the temperature measurer at the plurality of locations of the conveyance path and stores the created temperature profile in the storage.

18. The image forming apparatus according to claim 17, wherein, in a case where a new medium having the medium information not stored in the storage is designated as the recording medium, the control part determines an ideal temperature profile corresponding to the new medium on the basis of the medium information and the temperature profile already stored in the storage, and sets a temperature of the front surface heater to be raised on the basis of the temperature profile.

19. The image forming apparatus according to claim 18, wherein the control part performs machine learning when determining an ideal temperature profile corresponding to the new medium.

20. An image forming method for conveying a recording medium along a predetermined conveyance path and forming an image by ejecting ink onto a front surface of the recording medium when the recording medium passes through a predetermined drawing position, the image forming method comprising
first heating the recording medium on an upstream side of the drawing position,
wherein the first heating includes heating a front surface side and a back surface side of the recording medium to different temperatures when the recording medium has a multilayer structure.

21. The image forming method according to claim 20, wherein the first heating includes raising the back surface side of the recording medium to a predetermined target temperature and raising the front surface side of the recording medium to a temperature higher than the predetermined target temperature.

22. The image forming method according to claim 20, further comprising
second heating the back surface side of the recording medium in a section until the recording medium reaches the drawing position after the first heating.

23. The image forming method according to claim 22, wherein the second heating includes maintaining the back surface side of the recording medium at a predetermined target temperature.

24. The image forming method according to claim 20, further comprising
third heating the back surface side of the recording medium in a section until the recording medium having passed through the drawing position reaches a fixer on a downstream side.

25. The image forming method according to claim 24, wherein the third heating includes maintaining the back surface side of the recording medium at a predetermined target temperature.

26. The image forming method according to claim 20, wherein the first heating includes setting a temperature of the front surface side of the recording medium according to characteristics of the recording medium.

27. The image forming method according to claim 20, further comprising
setting a conveyance speed of the recording medium according to characteristics of the recording medium.

28. The image forming method according to claim 26, wherein the characteristics of the recording medium include a material and a thickness of each layer forming the multilayer structure.

29. The image forming method according to claim 20, further comprising
measuring a front surface temperature and a back surface temperature of the recording medium conveyed along the conveyance path,
wherein the first heating includes adjusting the temperature of the front surface side of the recording medium to be raised on the basis of the front surface temperature and the back surface temperature of the recording medium measured by the measuring.

30. The image forming method according to claim 20, further comprising:
measuring a front surface temperature and a back surface temperature of the recording medium conveyed along the conveyance path; and
adjusting a conveyance speed of the recording medium on the basis of the front surface temperature and the back surface temperature of the recording medium measured by the measuring.
